(19) United States
(12) Patent Application Publication
(10) Pub. No.: US 2014/0084817 A1
(43) Pub. Date: Mar. 27, 2014

(54) METHOD OF ENERGY AND POWER MANAGEMENT IN DYNAMIC POWER SYSTEMS WITH ULTRA-CAPACITORS (SUPER CAPACITORS)

(71) Applicants: Vijay Bhavaraju, Germantown, WI (US); Yakov L. Familiant, Brown Deer, WI (US); Steven C. Schmalz, Franklin, WI (US)

(72) Inventors: Vijay Bhavaraju, Germantown, WI (US); Yakov L. Familiant, Brown Deer, WI (US); Steven C. Schmalz, Franklin, WI (US)

(21) Appl. No.: 13/984,084

(22) PCT Filed: Jul. 20, 2011
(86) PCT No.: PCT/US11/44607

§ 371 Date: Nov. 20, 2013

Related U.S. Application Data
(60) Provisional application No. 61/365,986, filed on Jul. 20, 2010.

(51) Int. Cl. H02J 1/10; H02P 3/14; H02P 6/00

(52) U.S. Cl. CPC H02J 1/102; H02P 6/001; H02P 3/14
USPC 318/139; 307/46; 318/376

(57) ABSTRACT

A power management system includes an ultracapacitor and a charge shuttle including a power converter. The charge shuttle may be coupled with the ultracapacitor and may be configured to be coupled with a load. The charge shuttle can be configured to monitor one or more parameters of the load and the ultracapacitor, and to control energy flow between the load and the ultracapacitor based on or according to monitored parameters. The system may also include a battery or other rechargeable energy storage element.

### CROSS-REFERENCE TO RELATED APPLICATIONS

This application is a national stage filing based upon International PCT Application No. PCT/US2011/044607, with an international filing date of Jul. 20, 2011, which claims the benefit of the filing date of U.S. Provisional Patent Application Ser. No. 61/365,986, filed Jul. 20, 2010, the entire disclosures of which are incorporated herein by reference.

### BACKGROUND

1. Technical Field

The present disclosure relates generally to power management for motor loads and actuation systems, including power management systems using ultracapacitors and other energy storage devices for systems with regenerative loads and peak power demands.

2. Description of the Related Art

Electric power systems on modern vehicles (air, ground or marine), as well as small “islanded” power systems, may be considered “micro-grids” of generators and loads. Such microgrids consist of energy sources (e.g., mechanically driven generators, solar power modules, fuel cells, batteries, etc.), distribution networks, and a variety of loads (regenerative and non-regenerative). Such power systems are important to the More Electric Aircraft (MEA) concept. In commercial and military aircraft, the MEA concept is based upon the conversion of hydraulic, pneumatic, and bleed air powered systems on conventional aircraft to equivalent electrically powered systems. This conversion may, among other things, reduce system complexity, increase reliability, reduce fuel consumption, and reduce the maintenance burden of operating an aircraft. As a result, an MEA may utilize electromechanical actuators (EMA) or electro-hydraulic actuators (EHA) for many flight control surfaces. Such actuators and surfaces are becoming more numerous because the industry trend is towards more advanced flight control systems capable of improving aircraft stability through increasingly active actuation of flight control surfaces (ailerons, spoilers, flaps, elevators, rudders, etc.). More active actuation may result in less susceptibility to turbulent weather and/or permit aircraft body geometries with lower drag coefficients or reduced radar cross sections. These increasingly-numerous actuators have significant peak power demands and regenerative power characteristics. As a result, power and energy demand can vary from actuator to actuator, and also vary over time for a single actuator.

Systems and methods are known for supporting a load with variable power demand. One known method, typically used in large power systems, is peak power shaving. When the demand for power is low (or energy cost is low), available excess generator capacity is stored in batteries (or pumped storage) and is later released during high power demand or at times of high energy cost. Peak power shaving can, however, have multiple drawbacks or challenges, including excessive generator sizing, undesirable current and voltage transients, and a reduced battery lifespan associated with high stress and high utilization.

Conventional peak power shaving systems and other typical electric power systems may, however, be inadequate for the MEA concept for one or more reasons. First, the energy sources and distribution networks in typical systems commonly must be oversized to meet peak power requirements at a duty cycle of much less than 50%, resulting in an expensive, heavy, and excessively large solution. Second, typical systems do not effectively accommodate regenerative loads. One common solution to handle regenerative loads has been to dissipate the regenerated energy in a resistor. This solution reduces efficiency, adds bulky components, and is not suitable in applications where heat removal is difficult (e.g., MEA, Hybrid Electric Vehicle (HEV), Plug-in Hybrid Electric Vehicle (PHEV)).

Some power systems accommodate regenerative loads by using batteries, ultracapacitors, or both. FIG. 1 shows an exemplary configuration of a conventional power system, designated system 10. System 10 includes an energy source 12 and an ultracapacitor 14 electrically connected in parallel to a direct current (DC) microgrid 16. A bi-directional direct current to alternate current (DC-to-AC) power converter 18 acts as an interface between DC microgrid 16 and an alternating current (AC) microgrid 20. System 10 also includes a motor/generator 22 electrically coupled to AC microgrid 20.

In system 10, ultracapacitor 14 may reduce the current demand on energy source 12. But because of the parallel configuration, the voltage variation across ultracapacitor 14—and thus the energy storage capacity of ultracapacitor 14—is limited by energy source 12. This limitation is seen in equation 1 below:

E_{cap,available}=½C_{cap}(Vₘₐₓ²−Vₘᵢₙ²) (1)

where E_{cap,available} is actual available (useful) ultracapacitor energy, C_{cap} is the theoretical capacity of ultracapacitor 14, and Vₘₐₓ and Vₘᵢₙ are capacitor voltage before and after discharging, respectively. As equation (1) illustrates, a higher allowable voltage swing across the ultracapacitor would increase the available capacitor energy. A potential solution is to use ultracapacitor 14 alone, without power source 12. Real world data from some HEV systems indicates that most of the load current pulses are relatively short and bidirectional. In theory, if positive and negative pulses have the same duration and magnitude, a properly sized ultracapacitor 14 could be used alone. But an ultracapacitor used alone can be impractical for at least two reasons. First, load current is actually not symmetrical. Second, an ultracapacitor 14 (or bank of ultracapacitors) that could provide the required energy capacity on its own would be both extremely large and extremely expensive.

Another known system for dealing with variable power demand includes a first DC-to-DC converter between a battery and a load and a second DC-to-DC converter between an ultracapacitor and the load. A potential drawback of such a system is that, if the system requires that either the ultracapacitor or the battery be capable of supporting the load independently (which is often the case), both DC-to-DC converters must be sized to meet the maximum load current. With larger loads, both converters must support a large current, which can result in a large, overly complex, and/or expensive system.

The challenge of delivering and controlling the necessary peak power demands of loads, such as control surface actuators, anti-icing systems, environmental control systems, and the electrical starting of engines, while managing the size and weight of the aircraft's power distribution infrastructure, drives a need to more optimally store and re-distribute electrical energy. As such, a power management system is desired that addresses one or more of the above-identified deficiencies.

### SUMMARY

It is desirable for a power management system to maximize the capture of regenerative energy, minimize main power supply size, and extend the life of energy storage elements in the system. Such a power management system may include an ultracapacitor and a charge shuttle comprising a power converter and a controller. The charge shuttle may be coupled with the ultracapacitor and may be configured to be coupled with a load. The charge shuttle may be configured to monitor one or more parameters of the load and the ultracapacitor. The controller may be configured to control energy flow between the load and the ultracapacitor based on or according to one or more monitored parameters. The system may further include a second energy storage element coupled to the charge shuttle. The second energy storage element may be a battery or other source capable of providing energy for a longer duration than the ultracapacitor. The charge shuttle may be further configured to monitor one or more parameters of the second energy storage element. The controller may be further configured to control energy flow to and from the second energy storage element. The charge shuttle may be configured to perform charge balancing between the ultracapacitor and the second energy storage element. The charge shuttle may also be configured to direct regenerative energy from the load to the ultracapacitor or to the second energy storage element.

### BRIEF DESCRIPTION OF THE DRAWINGS

The present invention will now be described, by way of example, with reference to the accompanying drawings, wherein like reference numerals identify like components in the several figures, in which:

FIG. 1 is a diagrammatic view of a prior art power management system.

FIG. 2 is a diagrammatic view of a first embodiment of a power management system including a charge shuttle.

FIG. 3 is a diagrammatic view of the system of FIG. 2 in a first mode of operation.

FIG. 4 is a diagrammatic view of the system of FIG. 2 in a second mode of operation.

FIG. 5 is a diagrammatic view of the system of FIG. 2 in a third mode of operation.

FIG. 6 is a diagrammatic view of a second embodiment of a power management system including a charge shuttle.

FIG. 7 is a diagrammatic view of a third embodiment of a power management system including a charge shuttle.

FIG. 8 is a flow chart illustrating an exemplary control scheme for the charge shuttle of FIG. 7.

FIG. 9 is a graph illustrating simulated results of the power management system of FIG. 7 employing the control scheme of FIG. 8.

FIG. 10 is a diagrammatic view of a fourth embodiment of a power management system including a charge shuttle.

FIG. 11 is a diagrammatic view of a fifth embodiment of a power management system including a charge shuttle.

FIG. 12 is a diagrammatic view of a sixth embodiment of a power management system including a charge shuttle.

FIG. 13 is a diagrammatic view of an exemplary flight control system employing a charge shuttle for a more electric aircraft (MEA).

FIG. 14 is a flow chart illustrating a method of operating a power management system with a charge shuttle.

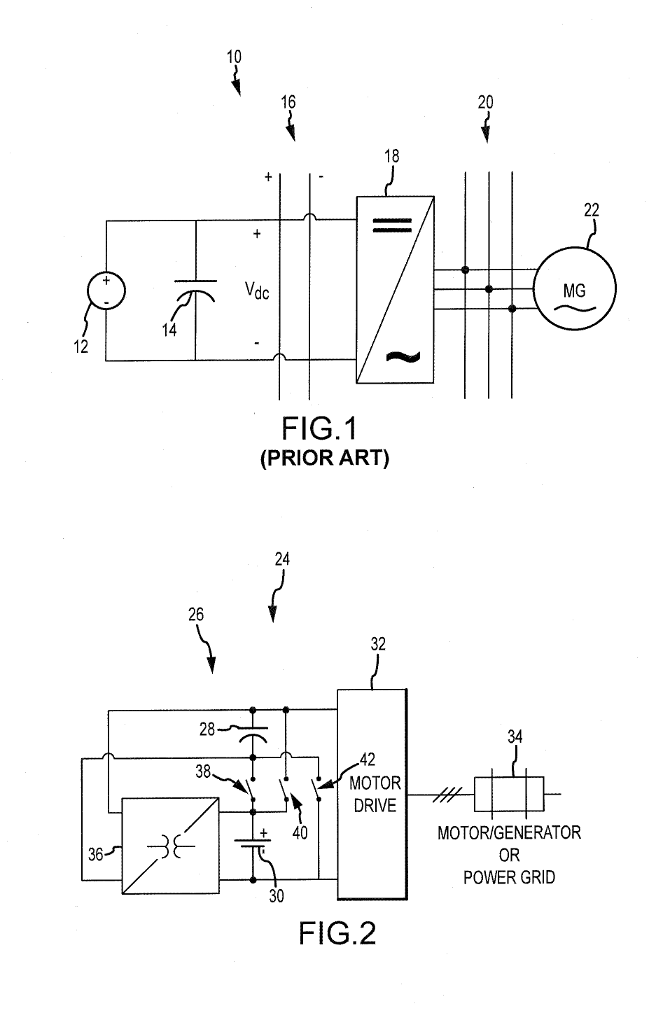

### DETAILED DESCRIPTION

FIG. 2 is a diagrammatic view generally illustrating a first embodiment of a power management system 24 in accordance with teachings of the present disclosure. Illustrated system 24 includes a charge shuttle 26, an ultracapacitor 28, a battery 30, a motor drive 32 that is connected to the system via DC link, and a load 34. As generally illustrated, the charge shuttle 26 may include a power converter 36 and a plurality of switches 38, 40, 42. The charge shuttle 26 may also include a controller (not shown) configured to actuate switches 38, 40, 42 and to control the direction of energy flow through converter 36.

Load 34 may include, for example only, a motor/generator such as may be used in a More Electric Aircraft (MEA), Hybrid Electric Vehicle (HEV), or Plug-in Hybrid Electric Vehicle (PHEV). The motor/generator may include various components, such as regenerative and non-regenerative loads, energy sources (e.g., mechanically driven generators, fuel cells), and distribution networks. The motor-generator may both draw power and energy from the system, and return power and energy to the system (e.g., through regenerative loads). In an embodiment, the motor-generator may include a Permanent Magnet Synchronous Machine Drive (PMSM Drive). Load 34 may additionally, or alternatively, include a DC power grid or AC power grid. In an embodiment where load 34 includes a power grid, motor drive 32 may be a power converter.

Ultracapacitor 28 and battery 30 can be configured as energy sources and storage elements for storing and providing energy for a load, such as a motor drive 32. Ultracapacitor 28 may include one, two, or more ultracapacitors, such as known in the art. Battery 30 may include one or more batteries or other rechargeable storage elements, including, for example, solar cells, fuel cells, and lithium-ion batteries. Ultracapacitor 28 and battery 30 may be used individually or in conjunction to provide power to load 34 via motor drive 32. If desired, both the ultracapacitor 28 and battery 30 may be configured to be recharged from load 34 through motor drive 32.

Combining an ultracapacitor 28 and a battery 30 in a single power management system provides benefits associated with both types of storage. For example, ultracapacitors may be quickly charged and discharged, and thus are commonly useful for providing high instantaneous or short-term power and for capturing a large amount of regenerative energy or power in a short period of time. Batteries generally charge and discharge more slowly, but often have a higher total energy capacity, and thus can be useful for satisfying a large longer-term energy need or for providing energy for a longer duration.

As generally illustrated charge shuttle 26 can be coupled to ultracapacitor 28, battery 30, and motor drive 32. Charge shuttle 26 can monitor (e.g., measure or estimate) one or more parameters of system 24 and direct the flow of energy in the system (e.g., to and from ultracapacitor 28, battery 30, and load 34 via motor drive 32) based on or according to the one or more monitored parameters. The charge shuttle 26 can be configured to actuate (i.e., open and close) switches 38, 40, 42, and control (i.e., switch the direction of energy flow through) power converter 36 (shown as a bi-directional isolated DC/DC converter) to isolate or connect ultracapacitor 28, battery 30 and load 34 in various configurations. Such actuation and control may be performed with a controller. Through dynamic switching of switches (e.g., switches 38, 40, 42) and an associated converter 36, a charge shuttle 26 can be configured to better manage or maximize beneficial characteristics of an ultracapacitor 28, a battery 30, and/or any energy sources and regenerative energy in load 34.

Charge shuttle 26 may be configured to monitor many different parameters of system 24. For example, without limitation, shuttle 26 may monitor the charge status, temperature, and current through battery 30. Similarly, shuttle 26 may be configured to monitor the charge status and current through ultracapacitor 28. On the load side, shuttle 26 may monitor the short-term power demand, the long-term energy demand, and/or the presence of any regenerative energy being provided from load 34 through motor drive 32. To monitor these and other parameters, charge shuttle 26 may be configured to directly measure a static or changing voltage or current, estimate a static or changing voltage or current, and/or receive information or feedback from another component of the system. By monitoring parameters, charge shuttle 26 can direct the flow of energy to achieve various goals, such as, for example, ensuring adequate power and energy for load 34, prolonging the useful life of battery 30, minimizing voltage transients throughout the system, and/or maximizing the recapture of regenerative energy.

FIG. 3 is a diagrammatic view of the system of FIG. 2 in a first “Boost” mode of operation. In the illustrated system 24, charge shuttle 26 can activate the Boost mode of operation by closing switch 38 and opening switches 40, 42. In the Boost mode of operation, battery 30 and ultracapacitor 28 are connected in series via switch 38. This configuration effectively boosts the DC link voltage input to motor drive 32. In an embodiment, the boosted input voltage can permit drive 32 to provide, for instance, field weakening capability for a permanent magnet motor. Field weakening can, for example, permit improved torque control of the motor at high speeds, which may result in better control in driving the motor load and in improved recovery of regenerative energy back to battery 30 and ultracapacitor 28. This mode of operation is generally suitable for applications that allow large variances in the DC link or bus voltage. Shuttle 26 can use power converter 36 to perform charge balancing by moving stored energy between battery 30 and ultracapacitor 28, and to adjust the proportion of the total DC link voltage supported by each storage element.

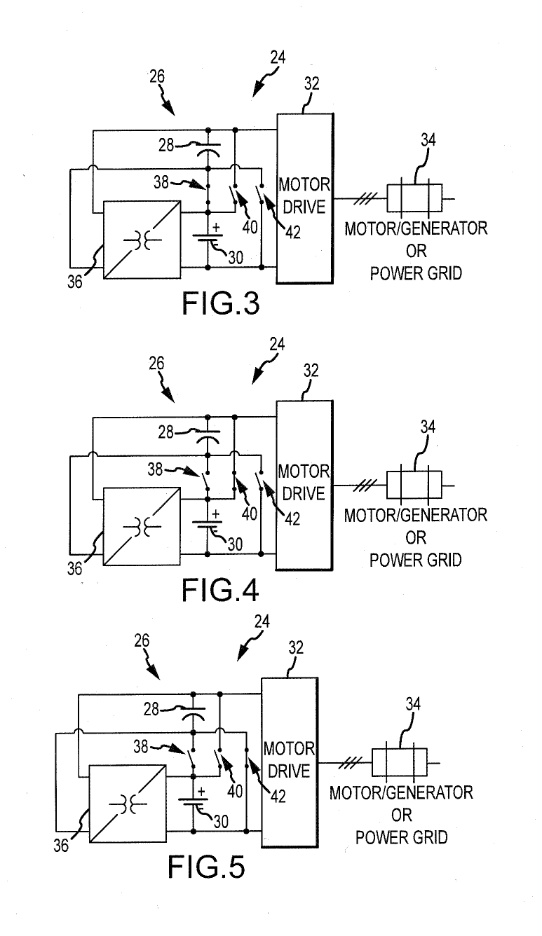

FIG. 4 is a diagrammatic view of the system of FIG. 2 in a second “Energy” mode of operation. In the illustrated system 24, charge shuttle 26 can activate the Energy mode of operation by closing switch 40 and opening switches 38, 42. In the Energy mode of operation, battery 30 is tied to the DC bus via switch 40, while ultracapacitor 28 is isolated from the bus by power converter 36. In this mode, system 24 can provide lower power levels (relative to the Boost mode) to load 34, but can provide that power level for a longer duration. Similarly, low level regenerative energy from load 34 can be used to charge battery 30 through motor drive 32. Power converter 36 may also direct energy from battery 30 to ultracapacitor 28 to better maximize the total energy stored in system 24 and to better maximize the ability of system 24 to satisfy later high power demand by load 34.

FIG. 5 is a diagrammatic view of the system of FIG. 2 in a third “Power” mode of operation. In the illustrated system 24, charge shuttle 26 can activate the Power mode of operation by closing switch 42 and opening switches 38, 40. In the Power mode of operation, ultracapacitor 28 is tied to the DC bus via switch 42, while battery 30 is isolated from the bus by power converter 36. This configuration is analogous to Energy mode, but ultracapacitor 28 and battery 30 essentially electrically “swap” positions in the circuit. Because ultracapacitor 28 is now tied to the DC bus, motor drive 32 can provide high power levels to (or quickly recovering regenerative energy from) load 34. Power converter 36 can be used to recharge battery 30 at a moderate rate that preserves battery life or to divert charge stored in battery 30 to supplement the power provided by ultracapacitor 28. In this instance, the DC link voltage can vary widely and is independent of the battery voltage.

The ability of embodiments of the disclosed system to convert to multiple configurations, as illustrated in FIGS. 2-5, allows for flexibility in power and energy management schemes and control logic. In applications where one or more of the above operating modes is not required or appropriate, the associated configuration switch or switches may be arrested or omitted. In an embodiment, motor drive 32 may, for instance, be replaced by a suitable bi-directional power converter when used to interface the energy storage with a power grid or power distribution bus.

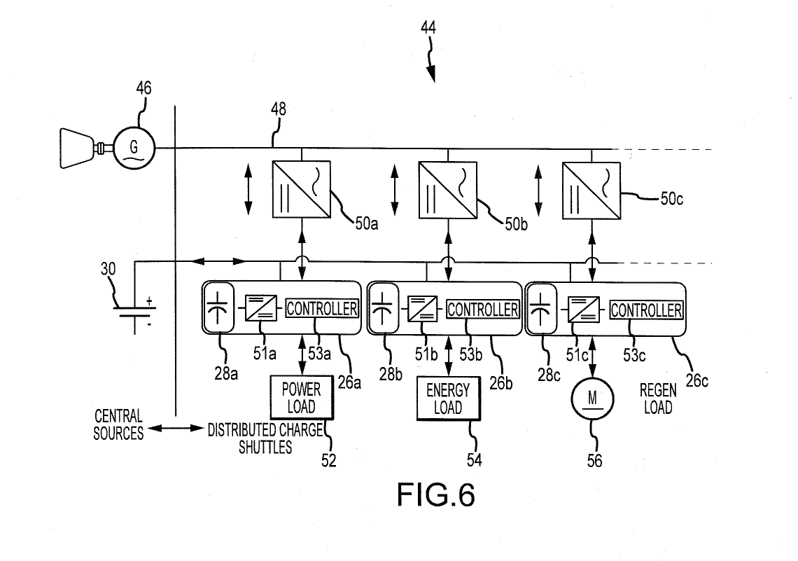

FIG. 6 is a diagrammatic view of a second embodiment of a power management system 44. The illustrated system 44 is shown including a generator 46, a main power bus 48, three AC/DC power converters 50a, 50b, 50c, three charge shuttles 26a, 26b, 26c, three ultracapacitors 28a, 28b, 28c, and a battery 30. As illustrated, each charge shuttle 26 may include a respective power converter 51 and a respective controller 53. Illustrated system 44 may further include three loads 52, 54, 56.

In the illustrated system 44, generator 46 and battery 30 are the “main” power supplies for the system 44. For example only, in a hybrid-electric vehicle (HEV) embodiment, generator 46 may be driven by the gasoline engine, and battery 30 may be the main vehicle battery or bank of batteries. Generator 46 can be configured to provide power to main power bus 48, from which system 44 draws power, as may a larger system and/or other sub-systems.

Loads 52, 54, 56 may have different characteristics. For example, load 52 may have a generally high power demand (i.e., short term), load 54 may have a relatively high energy demand (i.e., long-term), and load 56 may provide regenerative energy back to the system.

Charge shuttles 26a, 26b, and 26c may be respectively electrically coupled with and direct energy flow to and from loads 52, 54, 56. Each charge shuttle may monitor (e.g., measure or estimate) several parameters of main power bus 48, battery 30, its respective load, and its respective ultracapacitor 28. Based at least in part on monitored parameters, each controller 53a, 53b, 53c may determine a desired mode of operation (e.g., Boost, Energy, Power) and switch a respective charge shuttle to a desired mode to provide power or energy to a respective load or to receive power or energy from a respective load, and direct it to the proper source (i.e., ultracapacitor 28 or battery 30). Thus, each controller 53 may control the direction of power or energy flow through its respective power converter 51 and the connections between its respective ultracapacitor 28, the battery 30, and its respective load. Alternatively, one or more of charge shuttles 26a, 26b, 26c may simply provide power from main power bus 48 to a corresponding load. Each controller 53 may independently (i.e., independent of the other charge shuttles) determine a proper mode of operation and switch to a desired mode. The depicted system is exemplary only and a system 44, such as shown in FIG. 6, may be provided or scaled with more or fewer charge shuttles that are configured to provide power to more or fewer loads or groups of loads. Additionally, in an embodiment, controllers 53a, 53b, 53c may be implemented together as a single controller.

By using multiple charge shuttles coupled with multiple ultracapacitors, system 44 can individually manage the power and energy consumption of individual loads 52, 54, 56 or groups of loads on zonal power buses. This configuration can serve to reduce or minimize extreme fluctuations in demand that must be satisfied by generator 46 and battery 30. Reducing such fluctuations can result in better voltage regulation of the main distribution buses and reduced stress on the central power sources (i.e., generator 46 and battery 30).

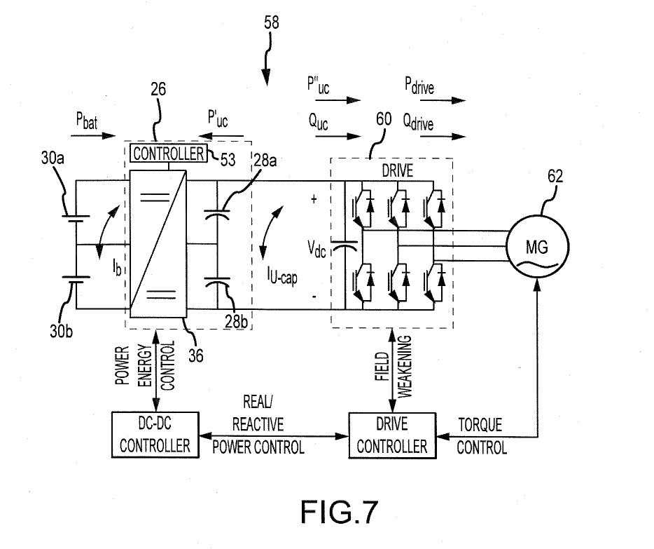

FIG. 7 is a diagrammatic view of a third embodiment of a power management system 58. The illustrated system 58 includes is shown including two ultracapacitors 28a, 28b, two batteries 30a, 30b, a charge shuttle 26 (which includes a power converter 36 and a controller 53), a drive controller 60, and a motor/generator 62.

Drive controller 60 may be configured to control the torque applied to one or more loads of motor/generator 62. Drive controller 60 may also facilitate a field weakening current for motor/generator 62. In an embodiment (e.g., when motor/generator 62 includes a PMSM), a field weakening current may be required to produce torque at speeds above a pre-determined threshold. Such a field weakening current may be reactive and may not produce any real power except for losses in semiconductors, electrical machines, and energy sources.

In embodiments, batteries 30 and ultracapacitors 28 can serve as storage elements to store energy recaptured from motor/generator 62 for later use by motor/generator 62. Batteries 30 may include one or more batteries or other re-usable storage elements. Ultracapacitors 28 may include one, two, or more ultracapacitors, such as known in the art. In the configuration shown, ultracapacitors 28 should be large enough to support the maximum load current, including any field weakening current. By supporting the load current, ultracapacitors 28 can reduce current through and load on batteries 30, prolonging the useful life of batteries 30.

In embodiments, charge shuttle 26 can be configured to monitor one or more system parameters and to facilitate energy flow through converter 36 between batteries 30 and ultracapacitors 28, for example, via a controller 53. Controller 53 may be configured to direct current through power converter 36 from ultracapacitors 28 to batteries 30, or vice-versa (i.e., power converter 36 is bi-directional). Controller 53 may also completely restrict current flow through converter 36 to electrically isolate batteries 30 from ultracapacitors 28 and from drive controller 60.

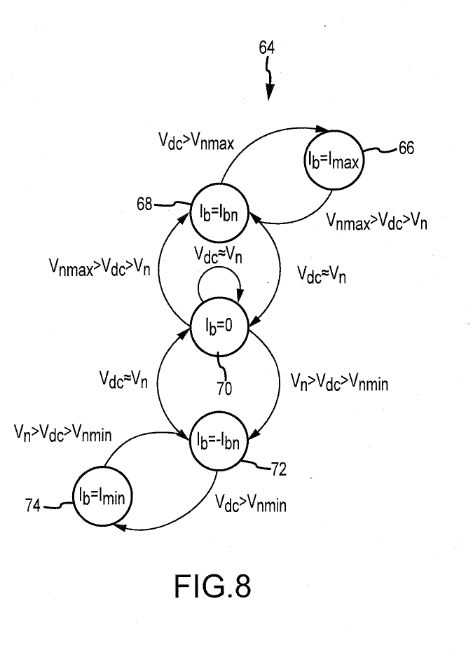

FIG. 8 is state diagram illustrating a control strategy 64 for a power management system. While the control strategy 64 will be described with reference to system 58 (as generally shown in FIG. 7), it is understood that control strategy 64 (and variations thereof) may find use with other power management systems, including other systems shown and described herein. Strategy 64 includes 5 states 66, 68, 70, 72, 74, defined by current flow I_{b} through power converter 36 and batteries 30. Positive I_{b} represents current flow into batteries 30 (i.e., increasing energy stored in batteries 30). The state of system 58 may change responsive to the voltage V_{dc} across the DC bus through which ultracapacitors 28 and drive controller 60 are electrically coupled relative to a nominal voltage Vₙ and relative to the load minimum and maximum operating voltages Vₙₘᵢₙ, Vₙₘₐₓ.

Beginning in the middle of FIG. 8, state 70 generally represents a state with zero current flow through batteries 30 and power converter 36. As long as V_{dc} remains near Vₙ V_{dc}≈Vₙ), batteries 30 remain isolated from ultracapacitors 28 and from any load in motor/generator 62. If V_{dc} rises above Vₙ, system 58 shifts to state 68. Such a voltage rise may occur, for example, when a regenerative load in motor/generator 62 produces power. In state 68, a current I_{bn} is driven through power converter 36, charging batteries 30. Properly sized ultracapacitors 28 will generally prevent V_{dc} from exceeding Vₙₘₐₓ. If V_{dc} drops such that V_{dc}≈Vₙ again, system 58 returns to state 70. But if the DC-bus voltage V_{dc} continues to rise and exceeds Vₙₘₐₓ, system 58 enters state 66. In state 66, power converter 36 will command maximum current I_{bmax}, thus forcing the regenerative energy back to the motor/generator 62 only as a last resort. This generally limits the DC-bus voltage below the absolute maximum input voltage specified for a particular load. Once V_{dc} drops below Vₙₘₐₓ, system 58 returns to state 68, from which it may return to state 70 when V_{dc}≈Vₙ.

From state 70, if V_{dc} drops below Vₙ, system 58 enters state 72. Such a drop may occur, for example, during a period of high load power demand. In state 72, a current −I_{bn} is driven through power converter 36, discharging batteries 30 to support V_{dc}. If V_{dc} rises such that V_{dc}≈Vₙ again, system 58 returns to state 70. But if the DC-bus voltage V_{dc} continues to fall and drops below Vₙₘᵢₙ, system 58 enters state 74. In state 74, power converter 36 will command maximum negative current I_{bmin} until batteries 30 are discharged or V_{dc} rises above Vₙₘᵢₙ.

The control strategy shown in FIG. 8 serves several functions, including power management, energy management, and voltage/speed management. With reference to P_{bat}, P′_{uc}, P″_{uc}, P_{drive}, Q_{uc}, and Q_{drive} as illustrated in FIG. 7, those functions may be expressed as shown in equations (2)-(6) below.

### Power Management

Ultracapacitors 28 support the source side of the load, as well as powering the load, as shown by equation 2:

P_{bat}−P′_{uc}+P″_{uc}=P_{load} (2)

Batteries 30 and ultracapacitors 28 provide or receive power to or from the load, as shown by equation (3) below:

P_{bat}+P″_{uc}P_{load} (3)

When charge shuttle 26 isolates batteries 30 from ultracapacitors 28, ultracapacitors 28 alone power the load or the load charges ultracapacitors 28 only, as shown by equation (4) below:

P″_{uc}=P_{load}; (4)

P_{bat}=0

### Energy Management

When no power is provided to the load, charge shuttle 26 facilitates the energy balancing of batteries 30 and ultracapacitors 28, as shown in equation (5) below:

P_{bat}P′_{uc}=0 (5)

### Voltage\Speed Management

In a field weakening mode, system 58 has DC voltage or motor-generator speed control, as shown in equation (6) below:

Q_{uc}Q_{load}=0 (6)

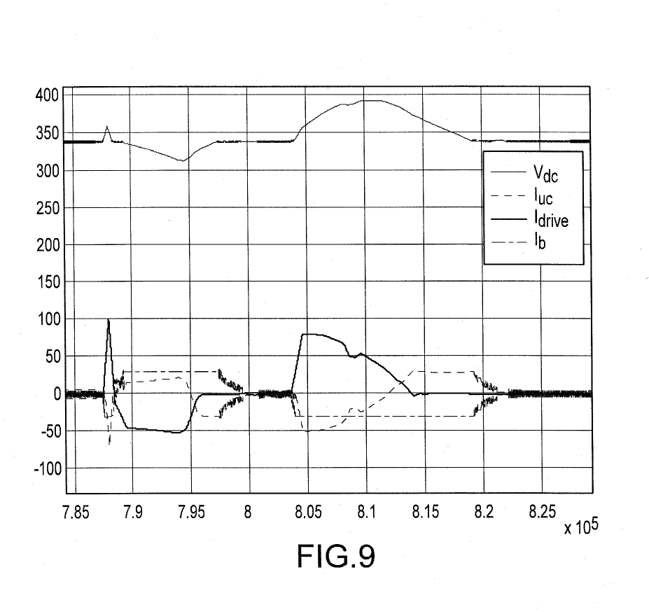

FIG. 9 is a graph generally illustrating simulated results of system 58 employing control strategy 64. The simulation was run on MATLAB® software, commercially available from MathWorks, Inc. The graph shows the nominal DC-bus voltage (V_{dc}), the load current (I_{drive}), the battery current (I_{b}), and the ultracapacitor current (I_{uc}). For this simulation, the nominal DC-bus voltage Vₙ is 340V, the upper and lower load voltage limits Vₙₘₐₓ and Vₙₘᵢₙ are 400V and 270V, respectively, and the maximum/minimum battery current I_{bmax}, I_{bmin} is ±30 A (charging or discharging). The load current profile is from a real hybrid-electric vehicle.

As generally shown in the graph, ultracapacitors 28 are able to handle most of the load current. The battery current is controlled to be less than or equal to the nominal continuous value. The DC-bus voltage V _{dc} stays in the specified region (i.e., below Vₙₘₐₓ and above Vₙₘᵢₙ). In a case with more available statistical data about the load cycle profile, battery engagement during the cycle could be reduced even more and energy use could be optimized. In other words, increased ability to predict the load variation will result in better performance with control strategy 64.

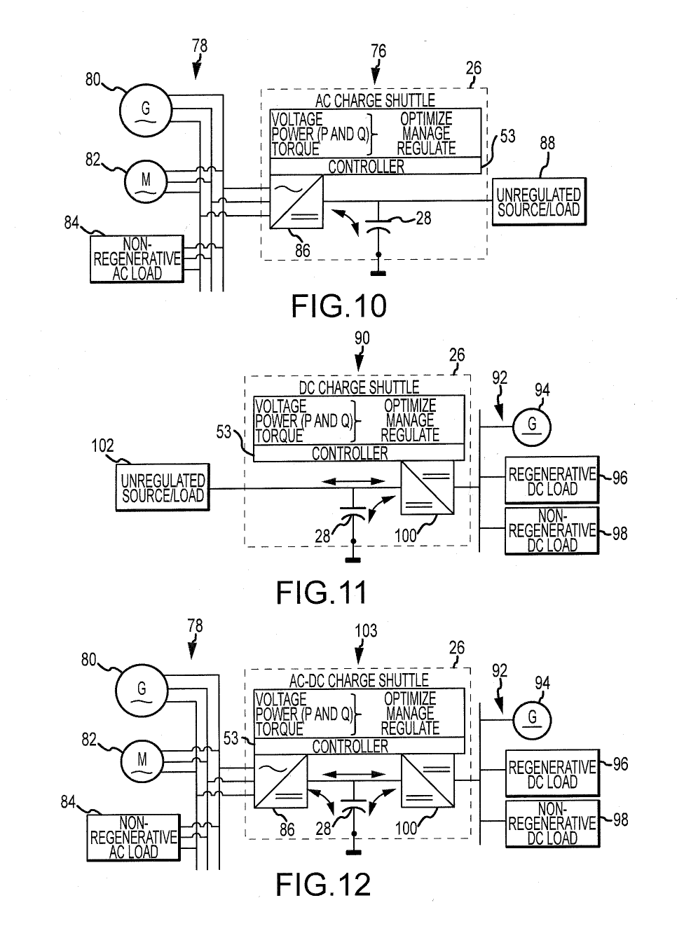

FIGS. 10-12 are diagrammatic views of additional alternate embodiments of a power management system. The embodiments generally illustrate different power management setups for different motor systems. Each motor system has a different combination of (1) current distribution requirement and (2) load bus type.

FIG. 10 generally illustrates an embodiment of a power management system 76 with an AC distribution system and a variable DC load bus. Illustrated system 76 includes an AC microgrid 78 electrically connecting an AC power source 80, an AC regenerative load 82, and a non-regenerative AC load 84. System 76 further includes a charge shuttle 26 and an ultracapacitor 28. Charge shuttle 26 itself may include a controller 53 and a bi-directional AC-to-DC converter 86. An unregulated DC source/load (i.e., motor/generator) 88 is also generally depicted.

FIG. 11 generally illustrates an embodiment of a power management system 90 with a DC microgrid and a DC load bus. Illustrated system 90 includes a DC microgrid 92 electrically connecting a DC power source 94, a regenerative DC load 96, and a non-regenerative DC load 98. System 90 further includes a charge shuttle 26 and an ultracapacitor 28. Charge shuttle 26 itself may include a controller 53 and a bi-directional DC-to-DC converter 100. An unregulated DC source or varying load (i.e., motor/generator) 102 is also shown.

FIG. 12 generally illustrates an embodiment of a power management system 103 with an AC distribution system, a DC distribution system, and a variable DC voltage bus. Illustrated system 103 includes an AC microgrid 78 electrically connecting an AC power source 80, an AC regenerative load 82, and a non-regenerative AC load 84. System 104 also includes a DC microgrid 92 electrically connecting a DC power source 94, a regenerative DC load 96, and a non-regenerative DC load 98. System 103 further includes a charge shuttle 26 and an ultracapacitor 28. Charge shuttle 26 itself may include a controller 53, a bi-directional AC-to-DC converter 86, and a bi-directional DC-to-DC converter 100.

In illustrated systems 76, 90, and 103, charge shuttle 26 (in the various illustrated configurations thereof) may be configured to monitor (e.g., measure or estimate) one or more system parameters (e.g. voltages, currents, power, motor load torque, etc.). The parameters may be respective of system loads, system power sources, and energy storage elements (i.e., ultracapacitor 28). Based on the state of the monitored parameters, controller 53 can control power converters 86, 100 to direct the flow of energy into or out of ultracapacitor 28. Controller 53 can also be configured to control the injection and removal of energy from ultracapacitor 28 to better maximize beneficial characteristics of ultracapacitor 28 and the various energy sources and regenerative loads in the system.

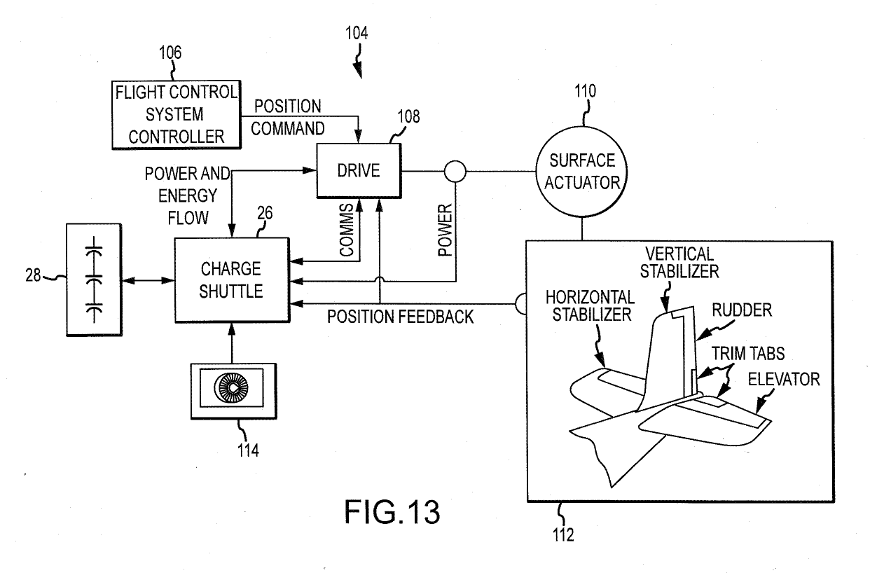

FIG. 13 generally illustrates a diagrammatic view of a power management system 104 that may be configured for a more electric aircraft (MEA). As mentioned previously, the More Electric Aircraft (MEA) concept is based, at least in part, on the conversion of mechanically powered systems used on conventional aircraft to equivalent electrically powered systems. One example is the flight control system, including exterior moveable surfaces used to control airflow around the aircraft, the electromechanical or electro-hydraulic actuators which move these surfaces, and the avionics and electrical power distribution components that deliver and control power to these actuators. Delivering and controlling the necessary peak power to the control surface actuators while limiting the size and weight of the power generation and distribution components is difficult, if not impossible, without utilizing energy storage and power management techniques.

In an embodiment, power management system 104 includes a flight control system avionics controller 106, an actuator drive 108, a surface actuator 110, and one or more control surfaces 112. Illustrated system 104 also includes a charge shuttle 26, an ultracapacitor 28, and a main power bus 114.

Flight control system avionics controller 106 may, for example, be configured to process commands from a pilot's controls (yoke and pedals) or autopilot, and to generate position command inputs for an actuator drive 108 controlling a particular surface 112. The control surface 112 may be, for example only, a rudder, a trim tab, a vertical stabilizer, a horizontal stabilizer, or an elevator.

Charge shuttle 26 can be configured to monitor one or more parameters of system 104 and to direct the flow of power and energy based on or according to one or more monitored parameters. Monitored parameters may include, for example and without limitation, the amount of energy stored in ultracapacitor 28, the amount of power available from main power bus 114, the availability of regenerative energy from surface actuator 110 (or from actuator drive 108), power and energy required by actuator drive 108, and the position of control surface 112. To monitor these and other parameters, charge shuttle 26 may, for instance, directly measure a static or changing voltage or current, estimate a static or changing voltage or current, and/or receive feedback from another component in the system.

Based on one or more monitored parameters, charge shuttle 26 can be configured to route power from either the aircraft's main electrical system bus 114 or from ultracapacitor 28, or a combination of both, to energize an actuator 110 to move a control surface 112 to a commanded position. If the command is to retract the surface or move it in such a manner that airflow actually assists or forces its movement, actuator 110 could, at least in part, act as a generator, thus sourcing regenerative energy back through drive 108. With such conditions, a charge shuttle 26 may be configured to direct the regenerative energy to ultracapacitor 28 for storage. The stored power may later be used by actuator 110 or slowly directed back to main power bus 114.

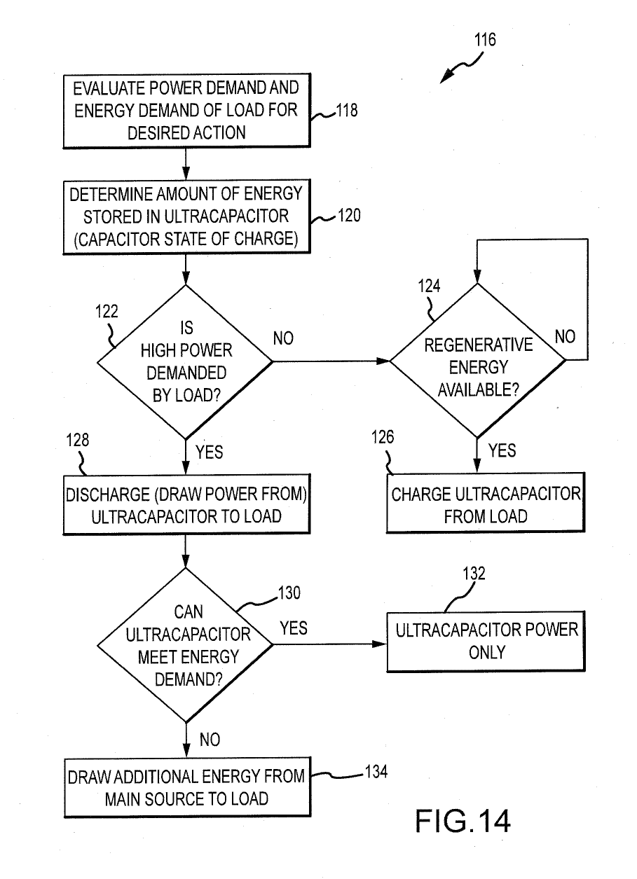

FIG. 14 is a flow chart generally illustrating an embodiment of a method 116 for managing power flow in a motor system. Method 116 may be performed by a charge shuttle. Method 116 will be described with reference to system 104 (generally illustrated in FIG. 13), but it is understood that method 116 may be used in connection with other systems. Furthermore, it is understood that method 116 may be modified for use in connection with a particular system configuration (e.g., number of loads, number of regenerative loads, number and type of rechargeable energy storage elements).

Method 116 begins at step 118 by evaluating the power demand and energy demand of a load for a desired action. For example, if flight controller 106 instructs actuator drive 108 to move a control surface to a new position, charge shuttle 26 may determine the amount of power and energy required to perform the actuation. In an embodiment, such a determination may involve direct measurement by charge shuttle 26 of a static or changing voltage or current, feedback from one of the other components in the system (e.g., position feedback from the control surface), and/or estimation of a static or changing voltage or current.

Next, in step 120, the amount of energy stored in the ultracapacitor (i.e., the capacitor state of charge) is determined. Then, at step 122, charge shuttle 26 queries whether a relatively high amount of power is demanded by the load for the desired action. Step 122 may involve comparing the power needed for the actuation (as determined in step 118) to the nominal power provided by the main power source. If relatively high power is not demanded by the load, the method may proceed to step 124, where charge shuttle 26 queries whether regenerative energy is available from the load. If regenerative energy is available, then the method may proceed to step 126, where charge shuttle 26 charges ultracapacitor 28 with the regenerative energy from the load. If regenerative energy is not available, charge shuttle 26 may continue to monitor the load to assess whether regenerative energy is available (step 124), or if power is demanded (step 122).

If, at step 122, relatively high power is demanded by the load, the method may proceed to step 128. At step 128, charge shuttle 26 discharges (i.e., draws power from) ultracapacitor 28 and directs it to the load. For example, the power may be provided to actuator drive 108. The method may proceed to step 130, where charge shuttle 26 queries whether ultracapacitor 28 can meet the energy demand of the desired movement (i.e., the energy demand determined at step 118). To make this determination, charge shuttle 26 may refer to the state of charge determined in step 120 and compare the state of charge to the energy demand determined in step 118. If ultracapacitor 28 contains sufficient charge, then the method may proceed to step 132, in which ultracapacitor 28 continues to be the power source for the desired movement. If ultracapacitor 28 does not contain sufficient charge for the desired movement, then the method may proceed to step 134, in which charge shuttle 26 draws additional power from the main power source (i.e., main power bus 114) and directs it to the load.

It should be understood that the steps of method 116, although presented in a linear fashion, are generally dynamic. Charge shuttle 26 may constantly monitor the power and energy demand of the load (or multiple loads), the state of charge in the ultracapacitor, the amount of power available from the main power bus, and/or the availability of regenerative energy from the load. Based on the monitoring, charge shuttle 26 may dynamically route power to and from ultracapacitors, the main power bus, the load (or multiple loads), and other energy storage elements (e.g., batteries) that may be present.

A power management system according to the present invention can provide many advantages. The following advantages are just a few possible examples. First, the main power source can generally be reduced in size (weight and volume) because the main generator does not need to supply peak power requirements on its own. Second, the system can help increase dynamic stability and voltage regulation in motor systems with limited capacity, such as MEA and HEV, by alleviating the need for the main power source to satisfy peak power requirements. Third, the amount of distribution lines and protection devices can commonly be reduced because the ultracapacitors provide local distributed energy storage and eliminate surge currents from the main power source. Fourth, system efficiency may be increased through storage and reuse of regenerative energy from loads and through optimal sizing of electrical system components (e.g., main power source, batteries, and ultracapacitors). Fifth, protective devices can be more reliable because the systems moderate current and voltage transients. Sixth, the useful life of the energy storage system may be increased because the stress on energy storage batteries may be alleviated by ultracapacitors.

The drawings are intended to illustrate various concepts associated with the disclosure and are not intended to so narrowly limit the invention. A wide range of changes and modifications to the embodiments described above will be apparent to those skilled in the art, and are contemplated. It is therefore intended that the foregoing detailed description be regarded as illustrative rather than limiting, and that it be understood that the following claims, including all equivalents, are intended to define the spirit and scope of this invention.

What is claimed:

1. A power management system for connecting different sources to a load having a variable energy demand and a variable power demand, the system comprising:
a first source;
a second source,
wherein the first source is configured to provide higher instantaneous power than the second source, and the second source is configured to provide energy for a longer duration than the first source; and
a charge shuttle comprising a power converter and a controller, the charge shuttle coupled with the first source and the second source and configured to be coupled with said load.

2. The power management system of claim 1, wherein the charge shuttle is configured to measure parameters of the system and the controller is configured to provide power to said load according to measured parameters.

3. The power management system of claim 1, wherein the charge shuttle is configured to measure parameters of the system and the controller is configured to provide energy to said load according to measured parameters.

4. The power management system of claim 1, wherein the charge shuttle is configured to measure parameters of the system and the controller is configured to provide power received from said load to at least one of the first source and the second source according to measured parameters.

5. The power management system of claim 1, wherein the charge shuttle is configured to measure parameters of the system and the controller is configured to provide energy received from said load to at least one of the first source and the second source according to measured parameters.

6. A power management system for connection to a load, the system comprising:
an ultracapacitor;
a charge shuttle comprising a power converter, the charge shuttle coupled with the ultracapacitor, and configured to be coupled with said load,
wherein the charge shuttle is configured to monitor one or more parameters of said load and the ultracapacitor, and to control energy flow between said load and the ultracapacitor according to monitored parameters.

7. The power management system of claim 6, wherein the power converter is a bi-directional power converter.

8. The power management system of claim 6, wherein the ultracapacitor is a first energy storage element, the system further comprising:
a second energy storage element coupled with the charge shuttle, wherein the charge shuttle is further configured to monitor one or more parameters of the second energy storage element, and to control energy flow between said load, the ultracapacitor, and the second energy storage element according to monitored parameters.

9. The power management system of claim 6, wherein said power converter is a first power converter, the system further comprising a second power converter coupled to the charge shuttle and configured to be coupled with a main power bus.

10. The power management system of claim 6, wherein the ultracapacitor is configured to support a field weakening current for said load.

11. The power management system of claim 10, wherein said load comprises a synchronous machine or a permanent magnet machine.

12. The power management system of claim 6, wherein the charge shuttle controls energy flow by actuating one or more switches to electrically connect the ultracapacitor with said load or electrically isolate the ultracapacitor from said load.

13. The power management system of claim 6, wherein said charge shuttle is configured to direct regenerative energy from said load to the ultracapacitor.

14. A power management system for connection to a load, comprising:
an ultracapacitor;
a battery; and
a charge shuttle coupled to the ultracapacitor and the battery and configured to be coupled to said load, the charge shuttle comprising:
a power converter; and
one or more switches,
wherein the charge shuttle is configured to control the power converter and toggle the switches to direct the flow of energy between the ultracapacitor, the battery, and said load.

15. The power management system of claim 14, wherein closing only a first one of the switches connects the ultracapacitor and the battery in series to said load.

16. The power management system of claim 15, wherein closing only a second one of the switches connects the ultracapacitor to said load and isolates the battery from said load.

17. The power management system of claim 16, wherein closing only a third one of the switches connects the battery to said load and isolates the ultracapacitor from said load.

18. The power management system of claim 14, wherein the charge shuttle is configured to direct regenerative energy from said load to one of the ultracapacitor and the battery.

19. The power management system of claim 14, wherein the charge shuttle is configured to perform charge balancing between the ultracapacitor and the battery.

20. A power management system for an aircraft having a main power bus, the system comprising:
an ultracapacitor;
an electrical actuator drive configured to draw power from at least one of the ultracapacitor and said main power bus and to control movement of an aircraft surface element; and
a charge shuttle coupled to the ultracapacitor and to the electrical actuator drive and configured to be coupled to said main power bus, the charge shuttle configured to monitor one or more parameters of said main power bus, the ultracapacitor, and the actuator drive and to control energy flow between said main power bus, the ultracapacitor, and the electrical actuator drive.

21. The power management system of claim 20 wherein the electrical actuator drive is configured to direct regenerative energy from said surface element to the charge shuttle when movement of said surface element is assisted by airflow over said surface element.

22. The power management system of claim 20, wherein said surface element is selected from the group consisting of:
a rudder;
a trim tab;
a vertical stabilizer;
a horizontal stabilizer; and
an elevator.

23. The power management system of claim 20, wherein the one or more parameters are selected from the group consisting of:
energy stored in the ultracapacitor;
power available from the main power bus;
regenerative energy available from the actuator drive;
power required by the actuator drive; and
position of said surface element.

24. The power management system of claim 20, wherein the one or more parameters are directly measured by the charge shuttle.

25. The power management system of claim 20, wherein the one or more parameters are estimated by the charge shuttle.
